(19) United States
(12) Patent Application Publication
(10) Pub. No.: US 2020/0020208 A1
(43) Pub. Date: Jan. 16, 2020

(54) PRINTING DEVICE AND POWER SUPPLY CIRCUIT OF PRINTING DEVICE

(71) Applicant: SEIKO EPSON CORPORATION, Tokyo (JP)

(72) Inventor: Akihiro UNO, Matsumoto-shi (JP)

(73) Assignee: SEIKO EPSON CORPORATION, Tokyo (JP)

(21) Appl. No.: 16/506,966

(22) Filed: Jul. 9, 2019

(30) Foreign Application Priority Data
Jul. 10, 2018 (JP) 2018-130781

(51) Int. Cl. G07G 1/12; G07G 1/00; G06F 1/26; H01C 7/00

(52) U.S. Cl. CPC G07G 1/12; H01C 7/008; G06F 1/266; G07G 1/0027

(57) ABSTRACT

A printer includes a driving circuit that drives an external device, a switching circuit that supplies first power to the external device, a thermistor wired to the switching circuit in parallel, a blocking circuit that blocks a supply of a second power to the switching circuit by a second signal, based on a predetermined voltage generated in the thermistor, a delay circuit that delays the second signal, and a processor that generates a first signal and drives the driving circuit. When the processor does not generate the first signal in a state in which the blocking circuit does not generate the second signal and the switching circuit blocks the supply of the first power, delay time by which the second signal is delayed by the delay circuit is set to be longer than a predetermined time period during which a current flows in the thermistor.

The present application is based on, and claims priority from JP Application Serial Number 2018-130781, filed on Jul. 10, 2018, the disclosure of which is hereby incorporated by reference herein in its entirety.

### BACKGROUND

### 1. Technical Field

The present disclosure relates to a printing device and a power supply circuit of a printing device.

### 2. Related Art

A point of sales (POS) system that includes a printing device and a cash drawer is known.

To open a drawer tray of the cash drawer, power is supplied to the cash drawer from a power supply circuit of the printing device in some cases. The power supply circuit includes a thermistor in some cases.

In a drawer kick (DK) driving circuit (short-circuit detecting circuit) included in a power supply circuit of a printing device according to JP-A-2015-50861, a thermistor is connected to an output line of the power supply circuit and a connection point connected to an end of a solenoid coil of the cash drawer serving as a load. The thermistor has a positive characteristic in which an electrical resistance value (resistance) increases with an increase in a temperature. When a current flows in the thermistor, the temperature of the thermistor increases due to the resistance of the thermistor. The resistance of the thermistor increases with the increase in the temperature, and the current flowing in the thermistor is suppressed (refer to JP-A-2015-50861).

In a DK driving circuit connected to a power supply circuit of a printing device according to JP-A-2015-136234, a thermistor is used (refer to JP-A-2015-136234), like JP-A-2015-50861.

In addition, in a short-circuit detecting circuit included in the power supply circuit of the printing device according to JP-A-2015-136234, a current flows from the power supply circuit to a cash drawer serving as a load in a forward direction of a diode (refer to JP-A-2015-136234).

A connector of another device may be erroneously connected to a terminal of a connector for the cash drawer of the printing device (printer) according to JP-A-2015-50861 or may be erroneously connected to a terminal of a connector for the cash drawer of the printing device (printer) according to JP-A-2015-136234, and a foreign substance may be inserted into the terminal and cause a short circuit. Thus, a short-circuit protecting circuit is required for protection.

In each of the power supply circuit of the printing device according to JP-A-2015-50861 and the power supply circuit of the printing device according to JP-A-2015-136234, a charging current flows upon connection to a device having a capacity load, a short-circuit detecting circuit detects the charging current and a short-circuit protecting circuit operates for protection in order to limit the supply of power. For example, a cash drawer having a capacity load or a device other than a cash drawer may be connected to a connector for a connection to a cash drawer. A device connected to the connector for the connection to the cash drawer may have a capacity load. It has been desirable that a short-circuit protecting circuit operate for a device having a capacity load in an abnormal state and not quickly operate in a normal state even when a charging current flows.

### SUMMARY

According to an aspect of the disclosure, a printing device includes a print head configured to perform printing on a medium, a connection section connectable to an external device, a driving circuit configured to drive the external device via the connection section, a switching circuit configured to switch between a state in which first power is supplied to the external device and a state in which the supply of the first power is blocked (cut off), a thermistor wired to the switching circuit in parallel, a blocking circuit that is configured to switch between a state in which second power is supplied to the switching circuit and a state in which the supply of the second power is blocked and that generates, based on a predetermined voltage generated between both ends of the thermistor due to a current flowing in the thermistor, a second signal to block the supply of the second power to the switching circuit and blocks the supply of the second power to the switching circuit, a delay circuit configured to delay the second signal, and a processor configured to generate a first signal and drives the driving circuit. When the processor does not generate the first signal and the driving circuit does not drive an external load that is a load of the external device in a state in which the blocking circuit does not generate the second signal and the switching circuit blocks the supply of the first power, delay time by which the second signal is delayed by the delay circuit is set to be longer than a predetermined time period during which the current flows through the thermistor toward the external load.

According to another aspect of the disclosure, a power supply circuit of a printing device includes a driving circuit that drives an external load, a switching circuit that switches between a state in which first power is supplied to the external load and a state in which the supply of the first power is blocked, a thermistor wired to the switching circuit in parallel, a blocking circuit that is configured to switch between a state in which second power is supplied to the switching circuit and a state in which the supply of the second power is blocked and that generates, based on a predetermined voltage generated between both ends of the thermistor, a second signal to block the supply of the second power to the switching circuit and blocks the supply of the second power to the switching circuit, a delay circuit that delays the second signal, and a processor that generates a first signal and drives the driving circuit. When the processor does not generate the first signal and the driving circuit does not drive the external load in a state in which the blocking circuit does not generate the second signal and the switching circuit blocks the supply of the first power, delay time by which the second signal is delayed by the delay circuit is set to be longer than a predetermined time period during which the current flows through the thermistor toward the external load.

### BRIEF DESCRIPTION OF THE DRAWINGS

FIG. 1 is a schematic external perspective view of a POS system according to an embodiment of the disclosure.

FIG. 2 is a diagram showing a schematic configuration of a printing device according to the embodiment of the disclosure and a cash drawer.

FIG. 3 is a diagram showing a schematic configuration of a circuit in a connection section in which the printing device according to the embodiment of the disclosure is connected to the cash drawer.

FIG. 4 is a diagram showing a configuration of an unlocking current supply section according to the embodiment of the disclosure.

FIG. 5 is a diagram showing an example of a characteristic of a thermistor according to the embodiment of the disclosure.

FIG. 6 is a diagram showing an example of a procedure for a process to be executed by the printing device according to the embodiment of the disclosure.

### DESCRIPTION OF EXEMPLARY EMBODIMENTS

An embodiment of the disclosure is described in detail with reference to the accompanying drawings.

### POS System

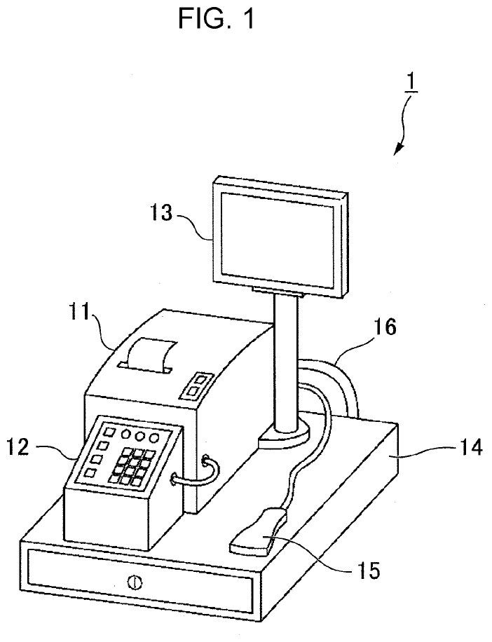

FIG. 1 is a schematic external perspective view of a POS system 1 according to the embodiment of the disclosure.

The POS system 1 includes a printing device 11, a terminal device 12, a display device 13, a cash drawer 14, a barcode scanner 15, and a connection cable 16.

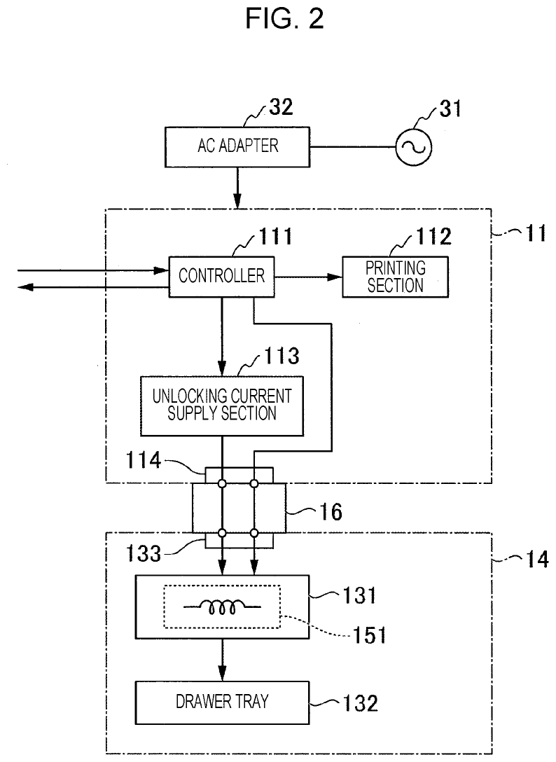

FIG. 2 is a diagram showing a schematic configuration of the printing device 11 according to the embodiment of the disclosure and the cash drawer 14.

FIG. 2 shows the printing device 11, the cash drawer 14, an external power supply 31, an alternating current (AC) adaptor 32, and the connection cable 16.

The printing device 11 includes a controller 111, a printing section 112, an unlocking current supply section 113, and a printing device-side connector 114.

The cash drawer 14 includes a locking mechanism 131, a drawer tray 132, and a drawer-side connector 133. The locking mechanism 131 includes a solenoid coil 151 (electromagnet).

Power is input to the printing device 11 from the external power supply 31 via the AC adaptor 32. The printing device 11 operates using the input power.

In addition, the printing device 11 is connected to the cash drawer 14 via the connection cable 16. The printing device 11 controls operations including the issuance of a receipt, the opening and closing of the drawer tray 132 of the cash drawer 14, and the unlocking of the drawer tray 132 of the cash drawer 14.

FIG. 2 shows an example in which the printing device 11 is connected to the cash drawer 14 via the connection cable 16. The printing device 11 may be connected to an external device other than the cash drawer 14 via the connection cable 16. The embodiment describes a case in which an external device including a cash drawer has a capacity load such as a capacitor. The device having the capacity load is, for example, a cash drawer including a booster circuit, a cash drawer for charging, voltage smoothing, or noise absorption, a POS peripheral device such as a buzzer, a mobile terminal, or the like.

The printing device 11 is connected to the terminal device 12 so that the printing device 11 can communicate with the terminal device 12. The printing device 11 receives various control commands transmitted by the terminal device 12 and executes various types of control based on the received control commands. In addition, the printing device 11 transmits results of the control to the terminal device 12.

The terminal device 12 is connected to the barcode scanner 15 so that the terminal device 12 can communicate with the barcode scanner 15. The terminal device 12 receives information transmitted by the barcode scanner 15 and indicating the name or price of a product or the like, generates printing data based on the received information, transmits the generated printing data to the printing device 11, and causes the printing device 11 to issue a receipt. The printing data includes a control command.

The terminal device 12 includes input keys for inputting the name or price of a product or the like and operational keys for configuring various settings of the POS system 1.

The terminal device 12 is connected to the printing device 11 so that the terminal device 12 can communicate with the printing device 11. The terminal device 12 transmits, to the printing device 11, a control command to instruct the printing device 11 to issue a receipt, a control command to instruct the printing device 11 to open and close the drawer tray 132 of the cash drawer 14, and the like. The terminal device 12 receives control results transmitted by the printing device 11.

The terminal device 12 is connected to the display device 13 so that the terminal device 12 can communicate with the display device 13. The terminal device 12 transmits information to be displayed to the display device 13.

The display device 13 includes a screen for displaying and outputting information.

The display device 13 is connected to the terminal device 12 so that the display device 13 can communicate with the terminal device 12. The display device 13 receives information transmitted by the terminal device 12 and to be displayed and displays the received information on the screen.

The display device 13 may display other information on the screen.

The cash drawer 14 stores the drawer tray 132, while the drawer tray 132 is openable and closable. The drawer tray 132 can store cash and the like therein.

The cash drawer 14 is connected to the printing device 11 via the connection cable 16.

The barcode scanner 15 radiates, for example, infrared light to a barcode printed on a product and detects the light reflected from the barcode, thereby reading the barcode.

The barcode scanner 15 is connected to the terminal device 12 so that the barcode scanner 15 can communicate with the terminal device 12. The barcode scanner 15 transmits information indicating details of the read barcode to the terminal device 12.

A functional configuration of the printing device 11 is described below.

The controller 111 includes a processor and a memory. The processor reads firmware stored in the memory and executes various types of control. The controller 111 receives a control command from the terminal device 12 and controls the sections of the printing device 11.

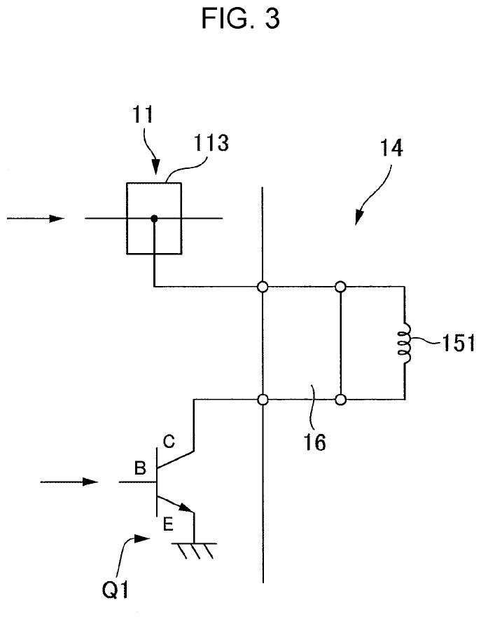

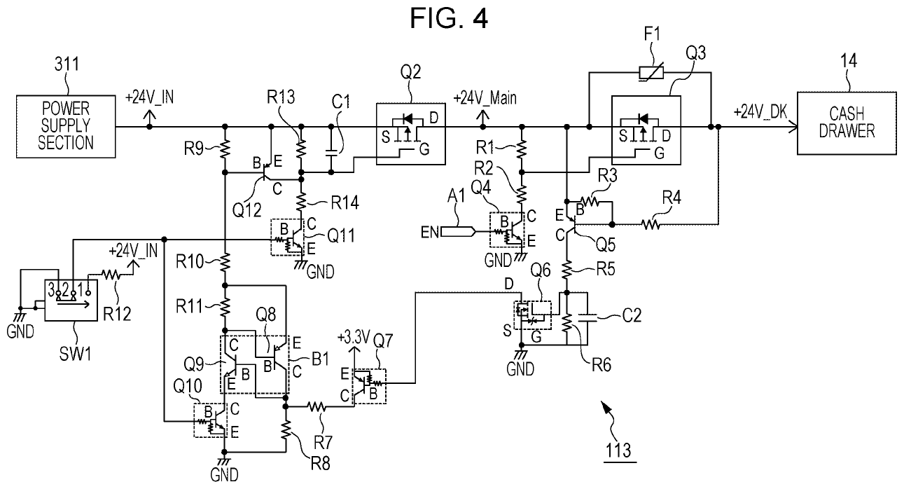

For example, the controller 111 receives, from the terminal device 12, a control command to open and close the drawer tray 132 of the cash drawer 14 and outputs, in response to the reception of the control command, a control signal (enable signal EN of a first input terminal A1 shown in FIG. 4) to supply first power to the cash drawer 14 to the unlocking current supply section 113. By this operation, a third transistor Q3 shown in FIG. 4 is turned on and the first power is supplied to the cash drawer 14. After that, the controller 111 generates a predetermined driving signal (first signal) for a time period specified in the control command and causes a driving circuit (first transistor Q1 shown in FIG. 3) to output a driving current to the locking mechanism 131 of the cash drawer 14 via the connection cable 16.

In addition, the controller 111 receives printing data (receipt information) generated and transmitted by the terminal device 12 based on the information indicating the details of the barcode read by the barcode scanner 15, outputs a portion of the received information or all the received information to the printing section 112 in response to the reception of the printing data.

The printing section 112 includes a mechanism (also referred to as printing mechanism for convenience of explanation) for performing printing on a medium such as a paper sheet. The printing section 112 includes a print head and a transport mechanism for transporting a medium.

The printing section 112 receives information output by the controller 111 and to be displayed, prints the received information on a printing sheet, and outputs results of the printing as a receipt. In this manner, the printing section 112 prints the receipt.

As the medium, a medium other than a printing sheet may be used, for example.

The unlocking current supply section 113 receives a control command (that is a control signal or the enable signal EN of the first input terminal A1 shown in FIG. 4), output by the controller 111, to supply the first power for driving the cash drawer 14, and turns on the third transistor Q3 shown in FIG. 4 to supply the first power via the connection cable 16 in response to the reception of the control command. In a state in which the first power is supplied to the cash drawer 14, the controller 111 outputs a first signal to turn on the first transistor Q1 shown in FIG. 3 and cause a predetermined driving current to flow to the locking mechanism 131 of the cash drawer 14 through the connection cable 16. The driving current releases a locked state of the locking mechanism 131.

The printing device-side connector 114 is connected to one end of the connection cable 16. The printing device-side connector 114 is connectable to an external device such as the cash drawer 14.

The printing device-side connector 114 may be an arbitrary connector such as a modular jack. In the embodiment, the printing device-side connector 114 fits with the end of the connection cable 16.

A functional configuration of the cash drawer 14 is described below.

The locking mechanism 131 includes a hook for fixing the drawer tray 132 (to cause the drawer 132 to be in a locked state), the solenoid coil 151 for releasing the hook, and a spring.

When the predetermined driving current (driving power or first power) is supplied from the unlocking driving current supply section 113 of the printing device 11 to the locking mechanism 131, and a predetermined driving signal (first signal) is input by the driving circuit to the locking mechanism 131 from the controller 111 that has received a control command from the terminal device 12 and is included in the printing device 11, the locking mechanism 131 causes a current to flow in the solenoid coil 151 and drives the solenoid coil 151. The locking mechanism 131 has a mechanism for releasing the hook from the drawer tray 132 by the driving of the solenoid coil 151 to release the locked state of the drawer tray 132 and cause the drawer tray 132 to pop out of the cash drawer 14 by the spring.

The locked state of the drawer tray 132 means that the drawer tray 132 is hung on the hook and held while being closed. Releasing the locked state of the drawer tray 132 means that the closed drawer tray 132 is released from the hook and opened.

In the embodiment, a user (person) operates the terminal device 12 and enters a predetermined instruction in the terminal device 12, and the terminal device 12 transmits a control command to open the drawer tray 132 to the printing device 11 in accordance with the predetermined instruction. The printing device 11 that has received the control command uses the controller 111 to execute control to output a first signal to the first transistor Q1 shown in FIG. 3 for a time period specified in the control command, turn on the first transistor Q1, cause a driving current to flow in the solenoid coil 151, and release the hook to open the drawer tray 132. After that, in the embodiment, the user can put and take money in and out of the drawer tray 132, push the opened drawer tray 132 with his or her hand or the like to store the drawer tray 132 in the cash drawer 14, hang the drawer tray 132 on the hook to fix the drawer tray 132, and close the drawer tray 132.

As a mechanism for locking the drawer tray 132 and a mechanism for unlocking the drawer tray 132, mechanisms with arbitrary structures may be used.

For example, the locking mechanism 131 includes the solenoid coil 151, an engaging section (not shown), an engaged section (not shown), and the like. A state in which the engagement of the engaging section with the engaged section is maintained is the locked state. By causing the current to flow in the solenoid coil 151 in the locked state, the engagement of the engaging section with the engaged section is released and the drawer tray 132 is opened. When the opened drawer tray 132 is closed by a physical force, the engaging section is engaged with the engaged section to cause the drawer tray 132 to be in the locked state.

The drawer-side connector 133 is connected to another end of the connection cable 16.

The drawer-side connector 133 may be an arbitrary connector such as a modular jack. In the embodiment, the drawer-side connector 133 fits with the other end of the connection cable 16.

FIG. 3 is a diagram showing a schematic configuration of a circuit in a connection section in which the printing device 11 according to the embodiment of the disclosure is connected to the cash drawer 14.

FIG. 3 shows the schematic configuration of the circuit in the section in which the printing device 11 is connected to the cash drawer 14 via the connection cable 16.

As a circuit configuration in the cash drawer 14, the solenoid coil 151 is shown.

As a circuit configuration in the printing device 11, the unlocking current supply section 113 and the transistor (that is the driving circuit and referred to as first transistor Q1 for convenience of explanation) are shown.

An output terminal of the unlocking current supply section 113 is connected to an end of the solenoid coil 151 via the connection cable 16.

A collector terminal of the first transistor Q1 is connected to another end of the solenoid coil 151 via the connection cable 16.

An emitter terminal of the first transistor Q1 is grounded.

The predetermined control command (that is the control signal or the enable signal EN of the first input terminal A1 shown in FIG. 4) output by the controller 111 is input to the unlocking current supply section 113. In response to the input of the control command, the unlocking current supply section 113 turns on the third transistor Q3 and supplies the predetermined driving current (driving power or first power) to the solenoid coil 151.

In this state, a predetermined command signal (first signal) output by the controller 111 is input to a base terminal of the first transistor Q1 based on the received control command. The predetermined command signal is a pulse signal with a time width of, for example, approximately 100 ms, but may be another signal. In response to the input of the predetermined command signal, the collector terminal and emitter terminal of the first transistor Q1 are electrically conducted to each other and a current (predetermined driving current) flows in the solenoid coil 151.

When the current flows in the solenoid coil 151, the solenoid coil 151 is driven to release the hook so that the drawer tray 132 is opened.

As an example, the resistance of the solenoid coil 151 is approximately 24Ω, and the driving current flowing in the solenoid coil 151 is approximately 1 A. The resistance and the driving current, however, are not limited to these values.

The first transistor Q1 may be included in the controller 111 in the printing device 11, for example. Alternatively, the first transistor Q1 may be included in the unlocking current supply section 113 or another section (not shown).

As another example, the first transistor Q1 may be included in the connection cable 16 or the cash drawer 14.

In the embodiment, although only the first transistor Q1 is shown as a circuit located on the side of the first transistor Q1 in order to simplify the description, but the circuit is not limited to this. Other various circuit elements may be used as the circuit located on the side of the first transistor Q1.

When a predetermined control command to open the drawer tray 132 is input to the controller 111 of the printing device 11 from the terminal device 12, the controller 111 generates a pulse signal that is at a high level for a time period specified in the control command. By outputting the pulse signal as a predetermined command signal (first signal) to the base terminal of the first transistor Q1, the first transistor Q1 is turned on for the time period specified in the control command.

The first transistor Q1 functions as a driving circuit for driving the locking mechanism 131 of the cash drawer 14. The first transistor Q1 serving as the driving circuit drives the external device such as the cash drawer 14 via the printing device-side connector 114.

When the terminal device 12 receives an instruction to open the drawer tray 132 in response to an operation by the user, the terminal device 12 outputs a predetermined control command to open the drawer tray 132 to the controller 111 of the printing device 11.

The instruction to open the drawer tray 132 may be generated by a device other than the terminal device 12. The device other than the terminal device 12 may be the printing device 11, the display device 13, or the like, for example.

### Unlocking Current Supply Section

FIG. 4 is a diagram showing a configuration of the unlocking current supply section 113 according to the embodiment of the disclosure.

The unlocking current supply section 113 includes a power supply section 311, a plurality of transistors (referred to as second to twelfth transistors Q2 to Q12 for convenience of explanation), a single thermistor (referred to as first thermistor F1 for convenience of explanation), a plurality of resistors (referred to as first to fourteenth resistors R1 to R14 for convenience of explanation), two capacitors (referred to as first and second capacitors C1 and C2 for convenience of explanation), a single switch (referred to as switch SW1 for convenience of explanation), and a single input terminal (referred to as first input terminal A1 for convenience of explanation).

A latch circuit (referred to as first latch circuit B1 for convenience of explanation) is constituted with eighth and ninth transistors Q8 and Q9.

In the embodiment, the cash drawer 14 corresponds to a load of an external device.

In the embodiment, the second transistor Q2, the third transistor Q3, and the sixth transistor Q6 are field-effect transistors (FETs).

The power supply section 311 outputs a predetermined voltage (+24V_IN in the embodiment) from an output terminal. The value of the voltage is, for example, +24 V, but may be another value.

The power supply section 311 includes an alternating current/direct current (AC/DC) converter (not shown), for example. An alternating current is input to the power supply section 311 from a commercial power supply. The power supply section 311 uses the AC/DC converter to convert the input alternating current to a direct current and outputs the direct current from the output terminal.

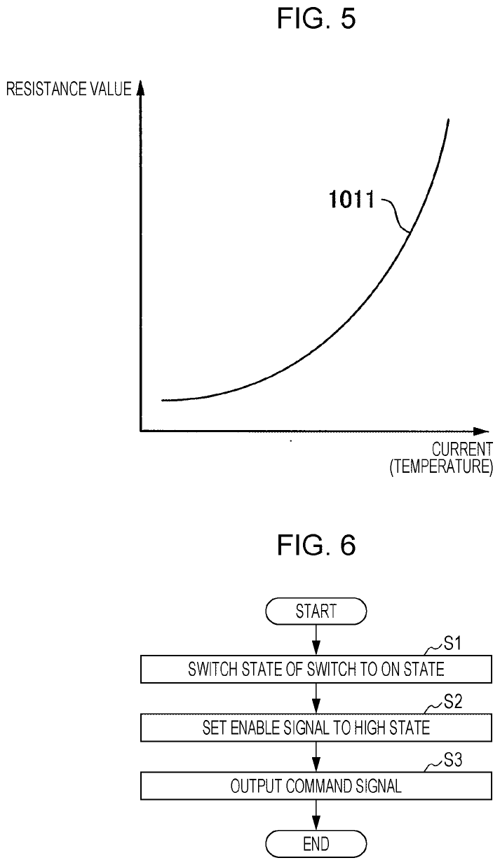

FIG. 5 is a diagram showing an example of a characteristic 1011 of the first thermistor F1 according to the embodiment of the disclosure.

In a graph shown in FIG. 5, an abscissa indicates a current flowing in the first thermistor F1 and an ordinate indicates a resistance value of the first thermistor F1. The example of the characteristic 1011 of the first thermistor F1 is shown.

In the embodiment, the characteristic 1011 of the first thermistor F1 is a positive characteristic. Specifically, as the current flowing in the first thermistor F1 is larger, the resistance value of the first thermistor F1 is larger.

Regarding the first thermistor F1, relationships between the current and the resistance value are the same as or similar to relationships between a temperature of the first thermistor F1 and the resistance value. Thus, even when the abscissa shown in FIG. 5 indicates the temperature of the first thermistor F1 instead of indicating the current, a trend of the characteristic 1011 indicating the relationships between the temperature and the resistance value is the same as or similar to that of the characteristic 1011 indicating the relationships between the current and the resistance value.

### Circuit Configuration of Unlocking Current Supply Section

Connection relationships between circuit elements of the unlocking current supply section 113 are described below.

The output terminal of the power supply section 311 is connected to a source terminal of the second transistor Q2.

A drain terminal of the second transistor Q2 is connected to a source terminal of the third transistor Q3.

A drain terminal of the third transistor Q3 is connected to the cash drawer 14.

The first thermistor F1 is wired to the third transistor Q3 in parallel. In other words, the first thermistor F1 and the third transistor Q3, which is a switching circuit, are wired to each other in parallel. Specifically, an end of the first thermistor F1 is connected to the source terminal of the third transistor Q3, and another end of the first thermistor F1 is connected to the drain terminal of the third transistor Q3.

A base terminal of the fourth transistor Q4 is connected to the first input terminal A1 to which the control signal (enable signal EN) is input.

The first resistor R1 and the second resistor R2 are connected in series to each other between the source terminal of the third transistor Q3 and a collector terminal of the fourth transistor Q4. Specifically, an end of the first resistor R1 and the source terminal of the third transistor Q3 are connected to each other, another end of the first resistor R1 and an end of the second resistor R2 are connected to each other, and another end of the second resistor R2 and the collector terminal of the fourth transistor Q4 are connected to each other.

An emitter terminal of the fourth transistor Q4 is grounded.

A connection point at which the first and second resistors R1 and R2 are connected to each other is connected to a gate terminal of the third transistor Q3.

An emitter terminal of the fifth transistor Q5 is connected to the source terminal of the third transistor Q3.

The third resistor R3 is connected between the emitter terminal of the fifth transistor Q5 and a base terminal of the fifth transistor Q5.

The fourth resistor R4 is connected between the drain terminal of the third transistor Q3 and the base terminal of the fifth transistor Q5.

The fifth resistor R5 and the sixth resistor R6 are connected in series to a collector terminal of the fifth transistor Q5. Specifically, the collector terminal of the fifth transistor Q5 and an end of the fifth resistor R5 are connected to each other, and another end of the fifth resistor R5 and an end of the sixth resistor R6 are connected to each other.

Another end of the sixth resistor R6 is grounded.

A gate terminal of the sixth transistor Q6 is connected to a connection point at which the fifth resistor R5, the sixth resistor R6, and the second capacitor C2 are connected to each other.

A source terminal of the sixth transistor Q6 is connected to the other end of the sixth resistor R6 and an end of the second capacitor C2 and is grounded.

A drain terminal of the sixth transistor Q6 is connected to a base terminal of the seventh transistor Q7.

An emitter terminal of the seventh transistor Q7 is connected to a predetermined voltage source. The voltage source supplies a voltage of, for example, +3.3 V. The value of the voltage may be another value.

The seventh resistor R7 and the eighth resistor R8 are connected in series to a collector terminal of the seventh transistor Q7. Specifically, the collector terminal of the seventh transistor Q7 is connected to an end of the seventh resistor R7, and another end of the seventh resistor R7 is connected to an end of the eighth resistor R8.

Another end of the eighth resistor R8 is grounded.

A collector terminal of the eighth transistor Q8, a base terminal of the ninth transistor Q9, and a connection point at which the seventh resistor R7 is connected to the eighth resistor R8 are connected to each other.

A base terminal of the eighth transistor Q8 is connected to a collector terminal of the ninth transistor Q9.

The ninth resistor R9, the tenth resistor R10, and the eleventh resistor R11 are connected in series to each other between the source terminal of the second transistor Q2 and the collector terminal of the ninth transistor Q9. Specifically, an end of the ninth resistor R9 is connected to the source terminal of the second transistor Q2, another end of the ninth resistor R9 is connected to an end of the tenth resistor R10, another end of the tenth resistor R10 is connected to an end of the eleventh resistor R11, and another end of the eleventh resistor R11 is connected to the collector terminal of the ninth transistor Q9.

An emitter terminal of the eighth transistor Q8 is connected to a connection point at which the tenth resistor R10 is connected to the eleventh resistor R11.

An emitter terminal of the ninth transistor Q9 is connected to a collector terminal of the tenth transistor Q10.

An emitter terminal of the tenth transistor Q10 is connected to another end of the eighth resistor R8 and is grounded.

The first switch SW1 includes three terminals. Specifically, the first switch SW1 includes a grounded terminal, a terminal connected to the predetermined voltage source via the twelfth resistor R12, and an output terminal. The voltage source supplies a voltage of +24 V supplied from the power supply section 311. The value of the voltage, however, may be another value.

The first switch SW1 is switched between an OFF state in which the output terminal is grounded and an ON state in which the voltage is supplied from the voltage source to the output terminal.

The output terminal of the first switch SW1, a base terminal of the tenth transistor Q10, and a base terminal of the eleventh transistor Q11 are connected to each other.

An emitter terminal of the eleventh transistor Q11 is grounded.

The thirteenth resistor R13 and the fourteenth resistor R14 are connected in series to each other between the source terminal of the second transistor Q2 and a collector element of the eleventh transistor Q11. Specifically, the source terminal of the second transistor Q2 is connected to an end of the thirteenth resistor R13, another end of the thirteenth resistor R13 is connected to an end of the fourteenth resistor R14, and another end of the fourteenth resistor R14 is connected to the collector terminal of the eleventh transistor Q11.

A base terminal of the twelfth transistor Q12 is connected to a connection point at which the ninth resistor R9 is connected to the tenth resistor R10.

A collector terminal of the twelfth transistor Q12 is connected to a connection point at which the thirteenth resistor R13 is connected to the fourteenth resistor R14.

An emitter terminal of the twelfth transistor Q12 is connected to the source terminal of the second transistor Q2.

The first capacitor C1 is connected between the source terminal of the second transistor Q2 and the connection point at which the thirteenth resistor R13 is connected to the fourteenth resistor R14.

The connection point at which the thirteenth resistor R13 is connected to the fourteenth resistor R14 is connected to the gate terminal of the second transistor Q2.

### Operations to be Executed in Unlocking Current Supply Section

An example of operations to be executed in the unlocking current supply section 113 is described below.

The power supply section 311 applies a predetermined voltage to the source terminal of the second transistor Q2. The following describes a case in which the power supply section 311 continuously applies the voltage.

When the power supply section 311 stops applying the voltage, the unlocking current supply section 113 does not operate.

The voltage (+24V_IN in the embodiment) is supplied from the power supply section 311 to the first switch SW1.

The first switch SW1 is switched between the OFF state and the ON state. The switching of the first switch SW1 may be manually performed by a user, for example. Alternatively, the switching of the first switch SW1 may be automatically performed in accordance with a control command from the controller 111 of the printing device 11 or a control command from the terminal device 12.

When the first switch SW1 is in the OFF state, the base terminal of the eleventh transistor Q11 is grounded via the first switch SW1. Thus, when the first switch SW1 is in the OFF state, a current does not flow between the collector terminal and emitter terminal of the eleventh transistor Q11, and the second transistor Q2 is in an OFF state. In this case, a voltage is not applied to the cash drawer 14 from the power supply section 311.

When the first switch SW1 is switched from the OFF state to the ON state, a predetermined voltage is applied to the base terminal of the eleventh transistor Q11 via the first switch SW1. Thus, the collector terminal and emitter terminal of the eleventh transistor Q11 are electrically conducted to each other, a voltage necessary for the gate terminal of the second transistor Q2 is applied to the gate terminal of the second transistor Q2, and the second transistor Q2 is turned on. In this case, the source terminal and drain terminal of the second transistor Q2 are electrically conducted to each other, and a voltage (+24V_Main in the embodiment) is applied from the power supply section 311 to the cash drawer 14, the printing mechanism of the printing section 112, and the like.

A voltage (second power) applied to an output terminal of the second transistor Q2 may be supplied to the first transistor Q1 of the cash drawer 14 or supplied to an arbitrary logic system or the like.

When the second transistor Q2 is in an ON state, there are two paths through which the voltage is applied to the cash drawer 14 from the power supply section 311. Specifically, there are a path through which the voltage (second power) is applied from the power supply section 311 via the first thermistor F1 to the cash drawer 14 and a path through which the voltage (second power) is applied from the power supply section 311 via the third transistor Q3 to the cash drawer 14.

The third transistor Q3 functions as a switching circuit for switching between a state in which the power (first power) is supplied to the cash drawer 14 and a state in which the supply of the power (first power) is blocked (cut off).

The predetermined enable signal is applied to the first input terminal A1 in advance. The enable signal is switched between a state (high state) in which the signal with a high voltage is output and a state (low state) in which the signal with a low voltage is output.

The enable signal is switched between the high state and the low state in accordance with control by the controller 111 of the printing device 11, for example. When the controller 111 erroneously operates or does not need to operate the cash drawer 14, the enable signal is in the low state and protects the third transistor Q3 and the cash drawer 14.

In the embodiment, for convenience of explanation, a state in which the enable signal to be applied to the first input terminal A1 is in the low state is referred to as steady state in which the supply of the first power to the cash drawer 14 is blocked.

In the embodiment, for convenience of explanation, a state in which the enable signal to be applied to the first input terminal A1 is in the high state is referred to as drawer driving state in which the first power is supplied to the cash drawer 14.

In the steady state, a voltage to be applied to the base terminal of the fourth transistor Q4 is low, and the collector terminal and emitter terminal of the fourth transistor Q4 are not electrically conducted to each other. Thus, a voltage applied to the gate terminal of the third transistor Q3 is low, and the source terminal and drain terminal of the third transistor Q3 are not electrically conducted to each other. In this case, the third transistor Q3 is in an OFF state, and the voltage is applied from the power supply section 311 via the first thermistor F1 to the cash drawer 14.

In the drawer driving state, a voltage necessary for the base terminal of the fourth transistor Q4 is applied to the base terminal of the fourth transistor Q4, and the collector terminal and emitter terminal of the fourth transistor Q4 are electrically conducted to each other. Thus, a voltage necessary for the gate terminal of the third transistor Q3 is applied to the gate terminal of the third transistor Q3, and the source terminal and drain terminal of the third transistor Q3 are electrically conducted to each other. In this case, the third transistor Q3 is in an ON state, and the voltage (first power) is applied from the power supply section 311 via the third transistor Q3 to the cash drawer 14.

In the embodiment, when the enable signal is switched by the controller 111 from the low state to the high state in the steady state, the third transistor Q3 is switched from the OFF state to the ON state and the steady state is changed to the drawer driving state.

In the drawer driving state, a voltage applied from the power supply section 311 via the second transistor Q2 passes through the third transistor Q3 in the ON state and is hardly applied to the first thermistor F1 (and a current does not flow in the first thermistor F1), and a voltage applied to the first thermistor F1 is almost zero (0).

Then, in the drawer driving state, the first transistor Q1 shown in FIG. 3 is temporarily switched to an ON state to supply the first power to the solenoid coil 151 via the path extending through the third transistor Q3. Thus, the controller 111 outputs, to the first transistor Q1, the first signal for the time period specified in the control command to drive the first transistor Q1, causes a current based on the first power to flow in the solenoid coil 151 to drive the solenoid coil 151, and drives the drawer tray 132 of the cash drawer 14 to open the drawer tray 132.

After that, when the enable signal is switched by the controller 111 from the high state to the low state, the third transistor Q3 is switched from the ON state to the OFF state and the drawer driving state is changed to the steady state.

In the embodiment, since the enable signal is used, it is possible to avoid a transient state of the third transistor Q3 and secure safety, for example.

Short-circuit protection in the steady state is described below.

When a short circuit occurs in a load that is a load of the external device such as the cash drawer 14 and is connected on the side of the drain terminal of the third transistor Q3 in the steady state, the third transistor Q3 is in the OFF state and a large current flows through the first thermistor F1.

In this case, the resistance value of the first thermistor F1 increases, the amount of a voltage drop increases in the first thermistor F1, and the amount of a voltage drop increases in the third resistor R3. Then, a voltage applied between the base terminal and emitter terminal of the fifth transistor Q5 increases. When the voltage applied between the base terminal and emitter terminal of the fifth transistor Q5 reaches a predetermined voltage (threshold), the fifth transistor Q5 is switched from an OFF state to an ON state. Thus, the second transistor Q2 is switched from the ON state to the OFF state after delay time (second signal) described later, and the voltage (second power) is not supplied from the power supply section 311 to the first thermistor F1, and the flow of the current (first power) to the load through the first thermistor F1 is stopped. This enables the short-circuit protection.

A short-circuit protection operation is described below.

When the fifth transistor Q5 is switched from the OFF state to the ON state, the second capacitor C2 starts to be charged via the fifth resistor R5 and the sixth resistor R6. When the charging of the second capacitor C2 is completed, a voltage necessary for the gate terminal of the sixth transistor Q6 is applied to the gate terminal of the sixth transistor Q6, and the sixth transistor Q6 is switched from an OFF state to an ON state. Then, the seventh transistor Q7 is switched from an OFF state to an ON state. Then, the eighth and ninth transistors Q8 and Q9 that constitute the first latch circuit B1 are switched from OFF states to ON states or the first latch circuit B1 is switched from an OFF state to an ON state. Then, a current flows between the collector terminal and emitter terminal of the tenth transistor Q10 and the twelfth transistor Q12 is switched from an OFF state to an ON state. Then, the difference between potentials of the gate terminal and source terminal of the twelfth transistor Q12 decreases, the difference between potentials of the gate terminal and source terminal of the second transistor Q2 decreases, and the second transistor Q2 is switched from the ON state to the OFF state.

Thus, the source terminal and drain terminal of the second transistor Q2 are not electrically conducted to each other and a voltage supplied from the power supply section 311 does not pass through the second transistor Q2.

In the unlocking current supply section 113, delay time from the time when a short circuit occurs in the load connected on the side of the drain terminal of the third transistor Q3 to the time when the short-circuit protecting circuit operates occurs. The delay time is a time period from the time when the short circuit occurs in the load connected on the side of the drain terminal of the third transistor Q3 to the time when the sixth transistor Q6 is turned on.

In the embodiment, a delay circuit is constituted by a circuit including the fifth resistor R5, the second capacitor C2, the sixth resistor R6, and the sixth transistor Q6.

In the embodiment, in a case in which a short circuit does not occur in the load in the steady state, the fifth to ninth and twelfth transistors Q5 to Q9 and Q12 are in OFF states.

In this case, the tenth transistor Q10 is an ON state but a current does not flow between the collector terminal and emitter terminal of the tenth transistor Q10.

In the embodiment, in a case in which a short circuit does not occur in the load, a resistance value of the third resistor R3 and a resistance value of the fourth resistor R4 are set so that a voltage applied between the base terminal and emitter terminal of the fifth transistor Q5 is lower than the predetermined voltage (threshold). Specifically, in the embodiment, a threshold for a current that causes a short-circuit protection operation to be started can be adjusted by adjusting the resistance value of the third resistor R3 and the resistance value of the fourth resistor R4.

In the embodiment, a blocking circuit that includes the fifth to tenth transistors Q5 to Q10, the twelfth transistor Q12, and the second transistor Q2 can switch between a state in which power (second power) is supplied to the third transistor Q3 serving as the switching circuit and a state in which the supply of the second power is blocked. A function of the blocking circuit that blocks the supply of the power to the third transistor Q3 based on a predetermined voltage generated between both ends of the first thermistor F1 is configured.

In a case in which the first transistor Q1 does not drive the cash drawer 14 in a state in which the blocking circuit does not operate and the third transistor Q3 blocks the supply of the first power, when a short circuit occurs on the side of the cash drawer 14, the blocking circuit operates based on the predetermined voltage generated between both ends of the first thermistor F1 and blocks the supply of the power to the third transistor Q3.

Specifically, when the predetermined voltage is generated between both ends of the first thermistor F1, a predetermined voltage or a voltage (second signal) higher than the predetermined voltage is generated between the base terminal and emitter terminal of the fifth transistor Q5. Specifically, the blocking circuit includes the fifth transistor Q5, and the predetermined voltage generated between both ends of the first thermistor F1 causes the generation of the voltage for turning on the fifth transistor Q5. For example, when a PNP transistor is used as the fifth transistor Q5, the predetermined voltage is approximately 0.6 V that causes the fifth transistor Q5 to be turned on. When another circuit element is used as the fifth transistor Q5, the value of the predetermined voltage may be another value.

When the predetermined voltage or a voltage higher than the predetermined voltage is generated between the base terminal and emitter terminal of the fifth transistor Q5, the fifth to ninth transistors Q5 to Q9 and the twelfth transistor Q12 are switched to ON states, and the second transistor Q2 is switched to the OFF state.

As described above, the voltage (+24V_Main in the embodiment) is applied from the power supply section 311 included in the unlocking current supply section 113 to the cash drawer 14, the printing mechanism of the printing section 112, and the like by turning on the second transistor Q2. Specifically, in the unlocking current supply section 113, power is supplied to the printing mechanism via the blocking circuit or the supply of the power to the printing mechanism is blocked by the blocking circuit.

A signal output to the seventh transistor Q7 when the sixth transistor Q6 is switched from the OFF state to the ON state is referred to as blocking signal (second signal). In the blocking circuit, when the sixth transistor Q6 generates the blocking signal, the supply of the power (second power) to the third transistor Q3 via the aforementioned path is blocked.

The blocking circuit can switch between a state in which the power is supplied to the third transistor Q3 serving as the switching circuit and a state in which the supply of the power to the third transistor Q3 is blocked. The blocking circuit generates, based on the predetermined voltage generated between both ends of the first thermistor F1, the blocking signal (second signal) to block the supply of the power to the third transistor Q3 and blocks the supply of the power (second power) to the third transistor Q3.

As described above, when a short circuit occurs in the load connected on the side of the drain terminal of the third transistor Q3 in the steady state, the voltage supplied from the power supply section 311 does not pass through the second transistor Q2 after delay time by which the blocking signal is delayed by the delay circuit in the unlocking current supply section 113.

Specifically, in the unlocking current supply section 113, in a case in which the first transistor Q1 does not drive the capacity load of the external device in a state in which the blocking circuit does not operate and the third transistor Q3 is in the OFF state, when a short circuit occurs on the side of the drain terminal of the third transistor Q3, the predetermined voltage is generated between both ends of the first thermistor F1 due to a current flowing through the first thermistor F1 toward the external device and the blocking circuit generates the blocking signal (second signal) based on the predetermined voltage generated between both ends of the first thermistor F1 after the delay time set in the delay circuit so as to block the supply of the power (second power) to the third transistor Q3.

Operation to be Executed when Capacity Load is Connected

An operation of the unlocking current supply section 113 when the external device that includes the capacity load and is the cash drawer 14 or the like is connected is described with reference to FIG. 4.

In the steady state, the second transistor Q2 is in the ON state and the third transistor Q3 is in the OFF state. When the external device including the capacity load is connected to the printing device-side connector 114, a charging current flows to the capacity load of the external device through the first thermistor F1.

In this case, the amount of a voltage drop in the first thermistor F1 increases and the amount of a voltage drop in the third resistor R3 increases. Then, a voltage applied between the base terminal and emitter terminal of the fifth transistor Q5 increases. When the voltage applied between the base terminal and emitter terminal of the fifth transistor Q5 reaches the predetermined voltage (threshold), the fifth transistor Q5 is switched from the OFF state to the ON state (and the second signal is generated).

Thus, the second capacitor C2 starts to be charged via the fifth resistor R5 and the sixth resistor R6. When the charging of the second capacitor C2 is completed, the voltage necessary for the gate terminal of the sixth transistor Q6 is applied to the gate terminal of the sixth transistor Q6 and the sixth transistor Q6 is turned on. When the sixth transistor Q6 is turned on, the aforementioned short-circuit protecting circuit operates.

Due to the operation (second signal) of the short-circuit protecting circuit, the source terminal and drain terminal of the second transistor Q2 are not electrically conducted to each other and the voltage supplied from the power supply section 311 does not pass through the second transistor Q2.

In the unlocking current supply section 113, the delay time from the time when the external device including the capacity load is connected to the time when the short-circuit protecting circuit operates occurs. The delay time is the sum of a time period for the charging of the second capacitor C2 and a time period from the completion of the charging of the second capacitor C2 to the time when the sixth transistor Q6 is turned on.

The delay time needs to be longer than a time period for the charging of the capacity load of the connected external device. As described above, it is assumed that the connected external device is, for example, a cash drawer including a capacitor of a booster circuit, a buzzer, or the like and that the time period for the charging of the capacity load of the external device is known. In the unlocking current supply section 113, the delay time can be easily set to be longer than the time period for the charging of the capacity load of the connected external device. Generally, a resistance value of a thermistor to be used to limit a current is in a range of several ohms to several tens of ohms. Thus, for example, when a thermistor to be used to limit a current is used as the first thermistor F1 to be used to charge the capacity load of the external device, the time period for the charging of the capacity load of the external device can be significantly shorter than the delay time.

In the unlocking current supply section 113, when the first transistor Q1 does not drive the external load that is the load of the external device in a state in which the blocking circuit does not operate and the third transistor Q3 serving as the switching circuit is in the OFF state, the delay time by which the blocking signal is delayed by the delay circuit is set to be longer than a predetermined time period during which the charging current flows through the first thermistor F1 toward the external load.

In the unlocking current supply section 113, in a time period to the completion of the charging of the second capacitor C2 after the completion of the charging of the capacity load of the external device, the amount of a voltage drop in the third resistor R3 decreases due to the stop of the flow of the charging current in the first thermistor F1, the difference between potentials of the base terminal and emitter terminal of the fifth transistor Q5 decreases to a voltage value lower than a predetermined voltage, the fifth transistor Q5 is turned off, and thus the voltage necessary for the gate terminal of the sixth transistor Q6 is not applied to the gate terminal of the sixth transistor Q6 and the sixth transistor Q6 is not turned on (and the second signal is not generated). Since the sixth transistor Q6 is not turned on, the short-circuit protecting circuit does not operate.

Specifically, in the unlocking current supply section 113, When a current does not flow in the first thermistor F1 before the delay time and after the predetermined time period during which the current flows through the first thermistor F1 toward the capacity load of the external device, and the predetermined voltage is not generated between both ends of the first thermistor F1 due to the stop of the flow of the current in the first thermistor F1, the blocking circuit does not generate the blocking signal (second signal). The second transistor Q2 is not turned off and supplies the second power to the third transistor Q3.

### Procedure for Process to be Executed in Printing Device

An example of a procedure for a process to be executed in the printing device 11 is described below.

FIG. 6 is a diagram showing an example of the procedure for the process to be executed in the printing device 11 according to the embodiment of the disclosure.

The example shown in FIG. 6 describes control to be executed to switch from the steady state to the drawer driving state to open the drawer tray 132.

### Step S1

The switch SW1 of the printing device 11 is switched from an OFF state to an ON state by a user, or the terminal device 12 is operated and the controller 111 receives a control command transmitted by the terminal device 12 and executes control to switch the first switch SW1 from the OFF state to the ON state. By the control, the state of the unlocking current supply section 113 is changed to the steady state. The second transistor Q2 is turned on to supply the second power to the third transistor Q3. Then, the process proceeds to a process of step S2.

### Step S2

When the terminal device 12 is operated by the user or the like and the state of the unlocking current supply section 113 of the printing device 11 changes to the steady state in response to the operation of the terminal device 12, the controller 111 of the printing device 11 switches the enable signal (control signal) to be input to the first input terminal A1 from the low state to the high state. This changes the state of the unlocking current supply section 113 to the drawer driving state. The third transistor Q3 is turned on to supply the first power to the cash drawer 14. Then, the process proceeds to a process of step S3.

### Step S3

In the printing device 11, the controller 111 receives a control command transmitted by the operated terminal device 12 in the drawer driving state. The controller 111 outputs a predetermined command signal (first signal) to the base terminal of the first transistor Q1 for a time period specified in the control command. Thus, a current flows in the solenoid coil 151 of the cash drawer 14 and the solenoid coil 151 is driven to open the drawer tray 132.

### Outline of Embodiment

As described above, the unlocking current supply section 113 of the printing device 11 included in the POS system 1 according to the embodiment includes the second capacitor C2.

Thus, when the driving circuit is in an OFF state and the external device is connected to the printing device 11, a time period to the time when the short-circuit protecting circuit operates is delayed in the unlocking current supply section 113 according to the embodiment. In the unlocking current supply section 113, since the output of the blocking signal from the blocking circuit is delayed by the delay time, the short-circuit protecting circuit does not operate until the elapse of the delay time. The delay time by which the blocking signal is delayed by the delay circuit is set to be longer than the predetermined time period during which the current flows through the first thermistor F1 toward the load of the external device. Thus, even when the external device is connected, the short-circuit protecting circuit does not operate until the elapse of the delay time in the unlocking current supply section 113, and the unlocking current supply section 113 can supply the power (first power) to the connected external device.

Even when the load of the external device includes a capacity component, the short-circuit protecting circuit does not operate until the elapse of the delay time in the unlocking current supply section 113. A charging current can flow to the capacity component of the load of the external device to charge the capacity component of the load of the external device.

In the unlocking current supply section 113 according to the embodiment, when the predetermined voltage is not generated between both ends of the first thermistor F1 due to the stop of the flow of the current in the first thermistor F1 before the delay time and after the elapse of the predetermined time period to the completion of the charging of the capacity load of the external device, the blocking circuit does not generate the blocking signal (second signal).

Thus, in the unlocking current supply section 113 according to the embodiment, when the supply of power does not need to be blocked, it is possible to suppress the blocking of the supply of the power (second power) to the third transistor Q3 serving as the switching circuit.

In the unlocking current supply section 113 according to the embodiment, when the driving circuit is in the OFF state and a short circuit occurs on the side of the external device, the predetermined voltage is generated between both ends of the first thermistor F1 due to the current flowing toward the side of the external device through the first thermistor F1, the blocking circuit generates the blocking signal based on the predetermined voltage after the delay time set in the delay circuit and blocks the supply of the power to the third transistor Q3 serving as the switching circuit.

Thus, in the unlocking current supply section 113 according to the embodiment, a short-circuit detecting circuit that prevents a large current from flowing to the external device after the delay time can be enabled.

In the unlocking current supply section 113 according to the embodiment, the blocking circuit includes the fifth transistor Q5 and the predetermined voltage generated between both ends of the first thermistor F1 is equal to the voltage that causes the generation of the voltage for turning on the fifth transistor Q5.

Thus, the blocking circuit can generate the blocking signal using the voltage that causes the generation of the voltage for turning on the fifth transistor Q5.

In the steady state, the unlocking current supply section 113 according to the embodiment can apply the predetermined voltage (first power) to the cash drawer 14 in a normal state and can detect an abnormality of a short circuit based on the first thermistor F1 and enables the protection upon the occurrence of the short circuit.

For example, the short-circuit protecting circuit is effective for the protection when a device other than the cash drawer 14 is connected to the connection cable 16 connected to the printing device 11 on the side of the cash drawer 14 with respect to the connection cable 16 or when a cable of another standard is connected to the printing device 11 instead of the connection cable 16 or when a foreign substance is inserted in the connection cable 16 or the like.

In the printing device 11 according to the embodiment, a system (referred to as power supply system for convenience of explanation) for supplying power to the cash drawer 14 via the third transistor Q3 and a system (referred to as control system for convenience of explanation) for giving a control signal to the cash drawer 14 via the first transistor Q1 are separately installed.

For example, when the control signal flows to the third transistor Q3 in the transient state, the third transistor Q3 may be broken. In the embodiment, this problem is solved by separately installing the power supply system having the third transistor Q3 and the control system having the first transistor Q1.

In the embodiment, the sixth transistor Q6 and the seventh transistor Q7 are mounted between the fifth transistor Q5 and the first latch circuit B1 in the unlocking current supply section 113. As another example, one or more resistors may be mounted between the fifth transistor Q5 and the first latch circuit B1.

In the embodiment, in the unlocking current supply section 113, the voltage of +3.3 V is used between the fifth transistor Q5 and the first latch circuit B1, and an operation of the short-circuit protecting circuit is masked or the short-circuit protecting circuit does not operate during a time period from the time when the power supply for the printing device 11 including the unlocking current supply section 113 is switched from an OFF state to an ON state to the time when the voltage of +3.3 V rises.

In the embodiment, in the unlocking current supply section 113, the first latch circuit B1 is configured using discrete semiconductors. As another example, the first latch circuit B1 may be configured using an integrated circuit (IC) or the like.

### Modified Examples

The unlocking current supply section 113 according to the embodiment has the configuration in which the third transistor Q3 and the first thermistor F1 are connected to each other in parallel. As a modified example, the unlocking current supply section 113 may has a configuration in which a resistor is used instead of the first thermistor F1 and connected to the third transistor Q3 in parallel.

When the configurations are compared with each other, the thermistor has low resistance and withstands a large current in general, and the configuration in which the first thermistor F1 is mounted is effective. On the other hand, when the resistor is used instead of the first thermistor F1, a resistor having a high power rating needs to be selected as the resistor used instead of the first thermistor F1.

Although the embodiment describes the case in which the second capacitor C2 is connected to the gate terminal of the sixth transistor Q6, the fifth resistor R5, and the sixth resistor R6, the embodiment is not limited to this. The second capacitor C2 may be connected to the eighth resistor R8 in parallel. Alternatively, the second capacitor C2 may be connected to the seventh resistor R7 in parallel.

Although the embodiment describes the case in which the delay time to the time when the short-circuit protecting circuit operates occurs using the second capacitor C2, the embodiment is not limited to this. Instead of the second capacitor C2, a reset IC or a timer IC including a voltage detector may be used, for example.

In addition, although the embodiment describes the case in which the seventh transistor Q7 and the seventh resistor R7 are mounted between the sixth transistor Q6 and the first latch circuit B1, the embodiment is not limited to this. While the seventh resistor R7 is mounted between the sixth transistor Q6 and the first latch circuit B1, the seventh transistor Q7 may not be mounted between the sixth transistor Q6 and the first latch circuit B1.

### Examples of Configurations

As an example of a configuration, a printing device (that is the printing device 11 in the embodiment) includes a printing mechanism (that is the print head of the printing section 112 and the transport mechanism in the embodiment) that performs printing on a medium, a connection section (that is the connector that is a modular jack or the like and is connected to the connection cable 16 in the embodiment) connectable to an external device (that is the cash drawer 14 in the embodiment), a driving circuit (that is the first transistor Q1 in the embodiment) that drives the external device via the connection section, a switching circuit (that is the third transistor Q3 in the embodiment) that switches between a state in which first power (that is power of +24V_DK in the embodiment) is supplied to the external device and a state in which the supply of the first power is blocked, a thermistor (that is the first thermistor F1 in the embodiment) wired to the switching circuit in parallel, a blocking circuit (that is the circuit including the fifth to tenth transistors Q5 to Q10, the twelfth transistor Q12, and the second transistor Q2 in the embodiment) that can switch between a state in which second power (that is the power of +24V_Main in the embodiment) is supplied to the switching circuit and a state in which the supply of the second power is blocked and that generates, based on a predetermined voltage generated between both ends of the thermistor due to a current flowing in the thermistor, a second signal (blocking signal) to block the supply of the second power (that is the power of +24V_Main in the embodiment) to the switching circuit and blocks the supply of the second power to the switching circuit, a delay circuit (that is the circuit including the fifth resistor R5, the second capacitor C2, the sixth resistor R6, and the sixth transistor Q6 in the embodiment) that delays the generation of the second signal (blocking signal), and a processor that generates a first signal and drives the driving circuit. As the blocking circuit, the second transistor Q2 may be treated, for example.

In the printing device, when the processor does not generate the first signal and the driving circuit does not drive an external load that is a load of the external device in a state in which the blocking circuit does not generate the second signal and does not operate and the switching circuit blocks the supply of the first power, delay time by which the second signal (blocking signal) is delayed by the delay circuit is set to be longer than a predetermined time period during which a current flows through the thermistor toward the external load.

As an example of the configuration, in the printing device, when the predetermined voltage is not generated due to the stop of the flow of the current in the thermistor after the elapse of the predetermined time period and before the delay time, the blocking circuit does not generate the second signal (blocking signal).

As an example of the configuration, in the printing device, in a case in which the processor does not generate the first signal and the driving circuit does not drive the external load in a state in which the blocking circuit does not generate the second signal and the switching circuit blocks the supply of the first power, when a short circuit occurs on the side of the external device, the predetermined voltage is generated between both ends of the thermistor due to a current flowing through the thermistor toward the external device, and the blocking circuit generates the second signal (blocking signal) based on the predetermined voltage after the delay time set in the delay circuit and blocks the supply of the second power to the switching circuit.

As an example of the configuration, in the printing device, the blocking circuit includes a transistor (that is the fifth transistor Q5 in the embodiment) and the predetermined voltage causes the generation of a voltage for turning on the transistor.

As an example of the configuration, in the printing device, the thermistor has a positive characteristic.

As an example of the configuration, in the printing device, the load of the external device includes a capacity component.

As an example of the configuration, in the printing device, power (that is the power of +24V_Main in the embodiment) is supplied to a print head via the blocking circuit (that is the second transistor Q2 that is a portion of the blocking circuit in the embodiment) or the supply of the power to the print head is blocked by the blocking circuit.

As an example of a configuration, a power supply circuit (that is the power supply circuit of the printing device 11 shown in FIGS. 3 and 4 in the embodiment) of a printing device includes a driving circuit that drives an external load (that is the load of the external device), a switching circuit that switches between a state in which first power is supplied to the external load and a state in which the supply of the first power is blocked, a thermistor wired to the switching circuit in parallel, a blocking circuit that can switch between a state in which second power is supplied to the switching circuit and a state in which the supply of the second power is blocked and that generates, based on a predetermined voltage generated between both ends of the thermistor, a second signal (blocking signal) to block the supply of the second power to the switching circuit and blocks the supply of the second power to the switching circuit, a delay circuit that delays the generation of the second signal (blocking signal), and a processor that generates a first signal and drives the driving circuit.

In the power supply circuit of the printing device, when the processor does not generate the first signal and the driving circuit does not drive the external load in a state in which the blocking circuit does not operate and the switching circuit blocks the supply of the first power, delay time by which the second signal (blocking signal) is delayed by the delay circuit is set to be longer than a predetermined time period during which a current flows through the thermistor toward the external load.

A program for enabling functions of arbitrary constituent sections included in the aforementioned devices (for example, the printing device 11, the terminal device 12, the display device 13, and the like) may be recorded (stored) in a non-transitory computer-readable recording medium (storage medium). The program may be read and executed by a processor of a computer system. It is assumed that the “computer system” includes an operating system (OS) or hardware such as a peripheral device. The “non-transitory computer-readable recording medium” is a portable medium such as a flexible disk, a magneto-optical disc, a read only memory (ROM), or a compact disc-ROM (CD-ROM) or a storage device such as a hard disk included in the computer system. The “non-transitory computer-readable recording medium” may be a recording medium that holds the program for a fixed time period and is a volatile memory (random access memory (RAM)) included in the computer system that serves as a server or a client when the program is transmitted via a network such as the Internet or a communication line such as a phone line.

The program may be transmitted from the computer system storing the program in the storage device or the like to another computer system via a transmission medium or a transmitted wave in the transmission medium. The “transmission medium” for transmitting the program has a function of transmitting information, like a network such as the Internet or a communication line such as a phone line.

The program may enable some of the aforementioned functions. The program may be a so-called differential file (differential program) that causes a combination of the program and a program recorded in the computer system to enable the aforementioned functions.

The embodiment of the disclosure is described above in detail with reference to the drawings. The specific configurations are not limited to the embodiment and include design and the like without departing from the gist of the disclosure.

What is claimed is:

1. A printing device comprising:
a print head configured to perform printing on a medium;
a driving circuit configured to drive an external device;
a switching circuit configured to switch between a state in which first power is supplied to the external device and a state in which the supply of the first power is blocked;
a thermistor configured to be wired to the switching circuit in parallel;
a blocking circuit that is configured to switch between a state in which second power is supplied to the switching circuit and a state in which the supply of the second power is blocked, generate a second signal to block the supply of the second power to the switching circuit and block the supply of the second power to the switching circuit when a current flows in the thermistor and a predetermined voltage is generated in the thermistor;
a delay circuit configured to delay the second signal; and
a processor configured to generate a first signal and drives the driving circuit, wherein
when the processor does not generate the first signal in a state in which the blocking circuit does not generate the second signal and the switching circuit blocks the supply of the first power, delay time by which the second signal is delayed by the delay circuit is set to be longer than a predetermined time period during which the current flows in the thermistor.

2. The printing device according to claim 1, wherein
when the predetermined voltage is not generated due to the stop of the flow of the current in the thermistor after the elapse of the predetermined time period and before the delay time, the blocking circuit does not generate the second signal.

3. The printing device according to claim 2, wherein
in a case in which the processor does not generate the first signal in a state in which the blocking circuit does not generate the second signal and the switching circuit blocks the supply of the first power, when a short circuit occurs in the external device, the predetermined voltage is generated in the thermistor due to the current flowing in the thermistor, and the blocking circuit generates the second signal based on the predetermined voltage after the elapse of the delay time set in the delay circuit and blocks the supply of the second power to the switching circuit.

4. The printing device according to claim 1, wherein
the blocking circuit includes a transistor, and
the predetermined voltage turns on the transistor.

5. The printing device according to claim 1, wherein
the thermistor has a positive characteristic.

6. The printing device according to claim 1, wherein
a load of the external device includes a capacity component.

7. The printing device according to claim 1, wherein
the blocking circuit blocks power to the print head.

8. A power supply circuit of a printing device, comprising:
a driving circuit configured to drive an external load;
a switching circuit configured to switch between a state in which first power is supplied to the external load and a state in which the supply of the first power is blocked;
a thermistor configured to be wired to the switching circuit in parallel;
a blocking circuit that is configured to switch between a state in which second power is supplied to the switching circuit and a state in which the supply of the second power is blocked, generate a second signal to block the supply of the second power to the switching circuit and block the supply of the second power to the switching circuit when a current flows in the thermistor and a predetermined voltage is generated in the thermistor;
a delay circuit configured to delay the second signal; and
a processor configured to generate a first signal and drives the driving circuit, wherein
when the processor does not generate the first signal in a state in which the blocking circuit does not operate and the switching circuit blocks the supply of the first power, delay time by which the second signal is delayed by the delay circuit is set to be longer than a predetermined time period during which the current flows in the thermistor.

9. The power supply circuit of the printing device according to claim 8, wherein
when the predetermined voltage is not generated in the thermistor due to the stop of the flow of the current in the thermistor after the elapse of the predetermined time period and before the delay time, the blocking circuit does not generate the second signal.

10. The power supply circuit of the printing device according to claim 9, wherein
in a case in which the processor does not generate the first signal in a state in which the blocking circuit does not generate the second signal and the switching circuit blocks the supply of the first power, when a short circuit occurs in the external load, the predetermined voltage is generated in the thermistor due to the current flowing in the thermistor, and the blocking circuit generates the second signal based on the predetermined voltage after the delay time set in the delay circuit and blocks the supply of the second power to the switching circuit.

11. The power supply circuit of the printing device according to claim 8, wherein
the blocking circuit includes a transistor, and
the predetermined voltage turns on the transistor.

12. The power supply circuit of the printing device according to claim 8, wherein
the thermistor has a positive characteristic.

13. The power supply circuit of the printing device according to claim 8, wherein
the external load includes a capacity component.

14. The power supply circuit of the printing device according to claim 8, wherein
the blocking circuit blocks power to a print head.
